(19) United States
(12) Patent Application Publication
(10) Pub. No.: US 2018/0357640 A1
(43) Pub. Date: Dec. 13, 2018

(54) METHOD, SYSTEM, AND APPARATUS FOR DATA TRANSMISSION AND TRANSACTIONS

(71) Applicants: Lars Olof KÄNNGÅRD, Bangkok (TH); Mats ENGSTRÖM, Bangkok (TH)

(72) Inventors: Lars Olof KÄNNGÅRD, Bangkok (TH); Mats ENGSTRÖM, Bangkok (TH)

(21) Appl. No.: 16/005,977

(22) Filed: Jun. 12, 2018

Related U.S. Application Data
(63) Continuation of application No. 16/001,016, filed on Jun. 6, 2018.
(60) Provisional application No. 62/516,330, filed on Jun. 7, 2017.

(51) Int. Cl. G06Q 20/38; H04L 9/32; H04L 9/08; G06Q 20/36; G06Q 20/32

(52) U.S. Cl. CPC G06Q 20/3829; H04L 9/3234; G06Q 2220/00; G06Q 20/367; G06Q 20/3278; H04L 9/088

(57) ABSTRACT

A method, a system and an apparatus for data transmission and transactions providing secured and efficient payments and data transactions. Users such as customers and merchants transact a secured token by using a user device and a transaction device without online services. The users have an account in a backend system, and the secured token is managed in the backend system. The users upload the token in their account via a terminal device. The token is transacted between the users in secured ways without using online services.

### CROSS REFERENCE TO RELATED APPLICATIONS

This application is a continuation of U.S. patent application Ser. No. 16/001,016 filed on Jun. 6, 2018, which claims priority to U.S. Provisional Patent Application No. 62/516,330, filed Jun. 7, 2017, and the entire contents of which are hereby incorporated by reference.

### BACKGROUND

Traditional payments between parties were handled as cash transactions. Payments then evolved into the use of credit cards, decreasing the demand for cash. More recently, other alternative forms of payments have arisen that provide further alternatives to cash and credit cards, making transactions easier for the purchaser as well as the vendor. However, as with many financial and data transactions, there is a significant concern regarding the security of these transactions.

Today, there are numerous payment solutions offered to consumers (users), merchants, enterprises, bank and non-banked business entities. As the use of mobile phones has become ubiquitous internationally, most user payment methodologies are built around the hardware and software capability of mobile phones (or other personal communication or computing devices). There are a large variety of software app (application) products for mobile phones, tablets and other types of computer based solution, with which a user may make payments via online as if the user's mobile phone were a traditional credit or debit card. Many solutions also provide some kind of ‘wallet’ where the user may pre-load money and hold its digital version of the ‘money’ in an electronic form via online. There are also solutions which are directly linked, via an online communication apparatus, to settle and charge or move money to the user's credit or debit card account in a bank. The traditional card-based solutions where one may use a card at a card acceptance devise, including EFT (Electronic Fund Transfer) terminals or POS (Point of Sales) devices, would accept a card with either magnetic-strip, microchip, smart chip, RFID and/or NFC functionality. However, all such devices require some sort of online capabilities or network accessibility to be able to settle and process the transaction. This leads to increased security risks with the transactions.

Card products are normally issued by a bank as a ‘co-branded’ Visa or MasterCard as an example, where the card brand is a brand for the bank and the card-brands operates global networks and regional or local centers to process, validate and settle each transaction, online. However, only about 25-35% of global consumers are so called banked users, meaning that they may enjoy traditional bank products and services the bank may offer.

The existing financial technology or e-commerce developers are focused on solutions for banked or bankable users and enterprises, which also is related the global IT and software industry. Their products typically rely heavily on card brands. Further, traditional card acceptance devices, such as EFTs, are a relatively large investment, either for the bank who place those devices in a retail location or for the merchant or vendor itself. In most of normal banked merchants, a number of EFT terminals are needed, for example each counter would need an EFT terminal, which makes the investment higher. In many countries, a whole row with different EFT or POS devices can be found, which each connected to a payment gateway who would offer different charges.

Merchants typically pay both a monthly ‘corporate account’ package fee to the bank (the Acquirer) as well as the bank ‘cut’ in-between each transactions with a so-called MDR (Merchant Discount Rate) fee, which is normally based on a percentage of each purchase transaction, plus, in some cases a transaction fee on top of the MDR, where the users have used a card or another device such a mobile-device to conclude the payment and get it charged to the users bank account. The MDR fee was first used in the 1950s with the development of credit cards. At that time, the bank or card brand took much of the risk because they effectively bought a claim against a user and, for that, they received a discount on purchases the user had charged to their account. Depending on who is the source from where a card is being used, the card-brand today has different rates of the MDR fees, for example online shops or services can pay as high as 5.00% or more and if you are using a direct-debit card (which one can only use if there is money in the account) than the MDR fee in some countries can be as low as 0.80%. In many countries the shop owner adds any such charges to the price of their products or services, otherwise they would not accept that form of payment.

Thus, as society uses more of these transactions and uses less and less cash, consumers may expect that such services will be both free of any additional fees imposed on them, as well as highly secure in order to effectively conduct these transactions. Likewise, although merchants should also expect a significant decrease in fees associated with non-cash transactions as they become the norm and must have a secure payment method in order to protect both their business income as well as provide a trusted place for consumers to shop or acquire services. Further, for the majority of global consumers who are unbanked, the current financial systems are required to be innovated.

### SUMMARY

According to at least one exemplary embodiment, a method, a system and an apparatus for data transmission and transactions are described. Such a method, system and an apparatus provide secure and efficient payments and data transactions.

Such a system of data transactions may include: tokens; one or more user device; one or more transaction device which is configured to receive the token from the user device, or transmit the token to the user device (the transaction device is generally held by a vendor, or an operator of an Point of Commerce (POC)); one or more terminal device; one or more account; and a backend system which is configured to manage the token in an account, receive the token from the user device via the terminal device, and transmit the token to the user device via the terminal device. In an exemplary embodiment, the user device and the transaction device transmit or receive the token without using an online service or absent a network connection to a remotely-located server. Also, in an exemplary embodiment, at the time when the transaction is made, the token is generated in the user device and stored in the vendors device (the transaction device) and later uploaded to a validation system (the backend system). Further, in an exemplary embodiment, the token is never stored in the account before being validated, and the values (money) is being exchange from a token account of the backend system to the vendors account.

In another exemplary embodiment, a transaction device which is utilized in the system may be described. Such a device may include: one or more display; one or more display driver which is configured to drive the display; one or more user device reader which is configured to communicate with one or more user device; one or more user device reader controller which is configured to communicate with the user device reader; one or more controller which is configured to communicate with the display driver and the user device reader controller; one or more memory which is configured to communicate with the controller; one or more power source which is configured to supply power to the transaction device; and one or more interface which is configured to receive and transmit data and communicate with the controller. Also, in an exemplary embodiment, the user device communicates with a smart-chip which may be used by the vendor, which the vendor has inserted before a translation can be made.

In still another exemplary embodiment, a method of managing a cryptographic key which is utilized in the system may be described. Such a method may include: dividing a map into multiple areas; and assigning a cryptographic key in each divided area. In an exemplary embodiment, the cryptographic key is assigned with a rule that the assigned cryptographic keys are the same among the divided areas which share their border, and one or more transaction of tokens which occurs in an area uses the cryptographic key assigned to that area.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is an exemplary flow chart showing data flow on a transaction platform.

FIG. 2 is an exemplary diagram showing a payment method and platform, along with data flow.

FIG. 3 is an exemplary diagram showing exemplary configurations on a surface of a transaction device.

FIG. 4 is an exemplary diagram showing a user device, such as a payment smart card.

FIG. 5 is an exemplary block diagram showing internal configurations of the transaction device.

FIG. 6 is an exemplary diagram of the transaction device and the user device.

FIG. 7 is an exemplary diagram showing a cryptographic key areas map.

FIG. 8 is an exemplary diagram of a collection box.

FIG. 9 is an exemplary diagram of a worn user device.

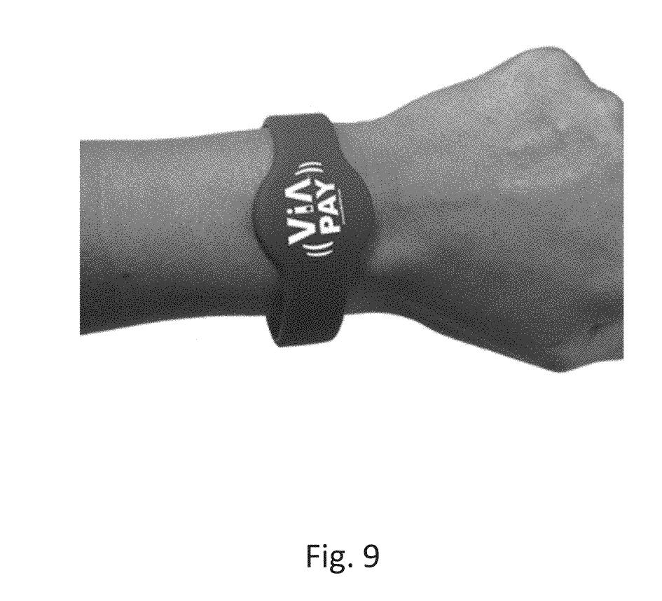

### DETAILED DESCRIPTION OF THE FIGURES

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein may be described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

Generally referring to the Figures, a method, a system and an apparatus for providing secure, efficient payments and a platform for providing secure, efficient payments and data transactions is described. According to an exemplary embodiment, users such as customers and merchants may transact a secured token by using a user device and a transaction device without using online services or connecting to a remotely located server. The user may have an account in a backend system, and the secured token may be managed in the backend system. The users may upload the token in their account via a terminal device. The token may be transacted between the users in secured ways without using online services or connecting to a remotely located server.

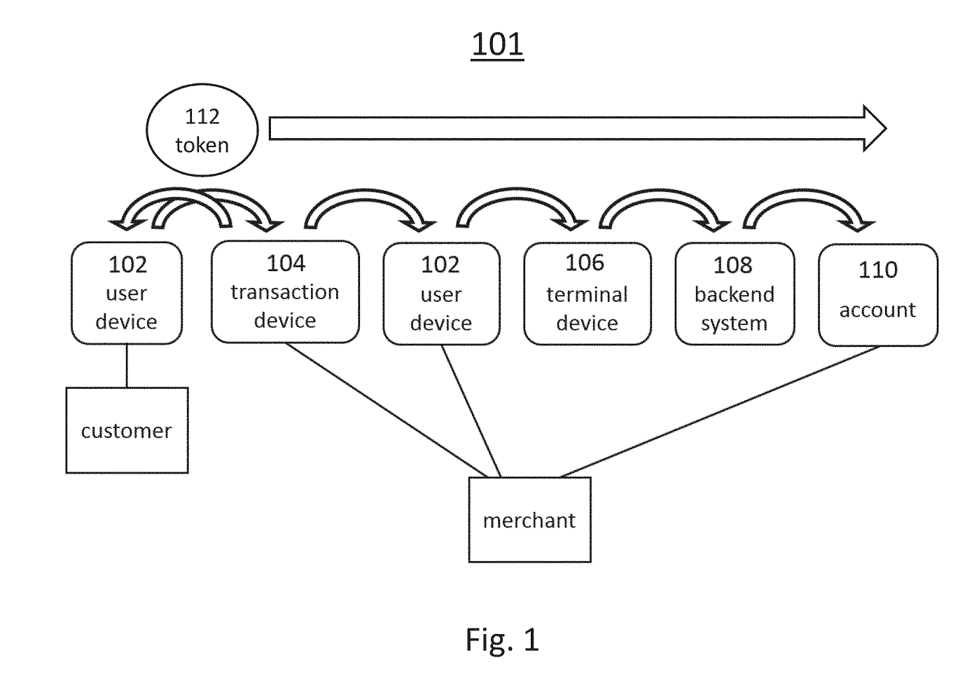

Turning now to exemplary FIG. 1, FIG. 1 shows an exemplary flow chart of data flow on a transaction platform. According to an exemplary embodiment, in the transaction platform 101, users such as customers and merchants may have their own user device 102. Also, the merchants may prepare their transaction device 104 for the customer to transact a secured token 112 between the customer's user device 102 and the transaction device 104. The merchants may have their account 110 in the backend system 108 where the secured token 112 may be managed. To upload the token 112 in their account 110, the merchant may transfer the token 112 stored in the transaction device into the merchant's user device 102. Then, the merchant may upload the token 112 from the merchant's user device 102 to the account 110 via the terminal device 106.

According to an exemplary embodiment, the transaction device 104, which may be a small, inexpensive electronic apparatus that may request, accept and manage secure “offline” transactions in a purchasing environment, for example an environment that handles small purchases from wallet-enabled user device 102.

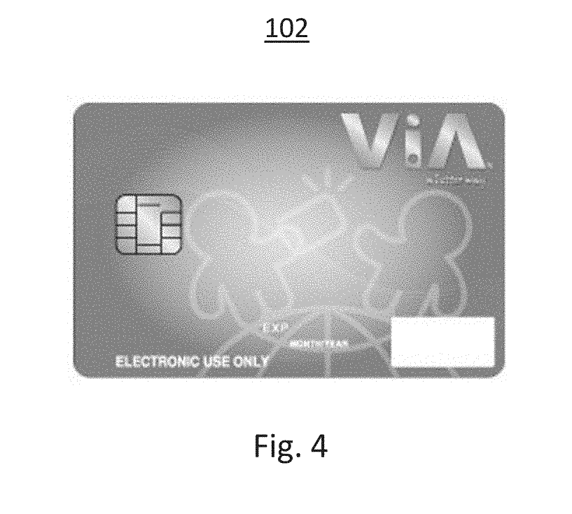

Also, in an exemplary embodiment, as shown in exemplary FIG. 4, the user device 102 which is a user owned device may be a card which has a smart chip, or a SIM card. Also, examples of the user device 102 may be a card with an approved embedded electronic wallet. Further, according to an exemplary embodiment, it may be appreciated that the term “wallet” may refer to any wallet with an extended software program to generate a payment token 112 upon a request. The user-device 102, for example, may also be a smart-chip equipped prepaid cash card, debit card, credit card or close-loop card which may communicate with the transaction device 104 and may also implement the wallet function. In an exemplary embodiment, the user device 102 may also be a smart chip embedded device which is not device dependent. It may also be a mobile SIM-based digital wallet or RFID/NFC (or the like) enabled wristband key-ring, NFC smart implant or any other type of user-device (user owned), which is equipped with an encryption processing and memory functionality, such as a smart chip, which generates upon a request a secure token 112 which is secured with asymmetric signing (or signed) method such as Public Key Infrastructure (PKI).

According to an exemplary embodiment, the token 112 or the request of the token 112 from the transaction device 104 may be signed so that the request may be validated that the token 112 or the request comes from a legitimate source. After having the request from the transaction device 104, the user device 102, then, may return the token as signed. Also, in an exemplary embodiment, the user device may also keep a token ‘history’ record for the purpose of an audit function, from which data is retrieved at the next time when an off-line wallet is being refilled. According to an exemplary embodiment, a token 112, as described herein, may have its data-details (record details) in plain text but it may also be encrypted with any type of encryption method, such as PKI, or any other desired method of encryption. An exemplary embodiment may use the asymmetric signed token 112 for an advantage that with the asymmetric signed token 112, the data record cannot be manipulated or changed. If anyone changes just a ‘byte’ of the secure token 112, the token 112 may become invalid. Also, an exemplary embodiment may use the asymmetric signed token 112 because the details of the token 112 may be displayed or printed, without harm, as further described below. In an exemplary embodiment, the token 112 may be encrypted as well as signed, and in some exemplary embodiments, the token 112 may only be loaded to its designated specific recipient account 110.

Still another exemplary benefit of the token system described herein is that an encrypted token 112 may have details that won't be visible, which might be a demand in a region or in a country attempting to uphold consumer data protection rules. The token 112 may also include more transaction data (details of a purchase) which may include, but is not limited to, item details, types of item(s) or product group(s) of items the user purchased, and different details related to VAT or taxes.

Exemplary embodiments described herein may also include a terminal device 106 with a variety of components and functionalities. For example, some additional components include a multi-function keypad. In an exemplary situation, the vendor clerk would typically, just enter the amount of such a purchase event (the amount). According to exemplary embodiment, the multi-function keypad may provide a method of entering each item with a predefined product code or use a pre-programmed key as a product entry calculator, and also a multi-function keypad, where alternative ways of ‘pressing’ a button, different pre-stored values or functions may be used.

Additionally, according to an exemplary embodiment, the terminal device 106 may access to an account 110 of a merchant, and the account 110 may in a backend system 108.

Also, in an exemplary embodiment, any NFC/RFID smart card or brand/concept such as a mass-transportation card with a wallet and extended software may be used as the user device 102. Additionally, a wallet, such as a third party or external wallet, with a contactless smart chip card, may extend their firmware in such method that when a transaction device 104 requests a token 112, the firmware generates a token 112. Then, when the token arrives to the backend system 108, a request for payment may be sent to the wallet operator.

Additionally, exemplary embodiments described herein may be described as offline, simple, and low-cost solution, which may be used by any and all who need to receive a ‘value’ (payment). Examples described herein may involve a physical interaction between parties. The holder/owner of the user device 102 may communicate the token 112 to the backend system, in one or another way, which is further explained herein.

The owner/holder of the user device 102, i.e. the merchant, can, in an exemplary case where the owner has another shop nearby that uses a terminal device 106, perform the following: 1) Place his own user device 102 on the transaction device 104 and either with a function key or by default may upload or store secure token(s) 112 to his own user device 102 (for example after requesting a PIN code); and 2) The merchants thereafter goes to the terminal device 106 operating an authorized token forward software module and insert or touch the user device 102 to the terminal device 106, where after the token(s) 112 are transferred to the backend system 108.

The terminal device 106 operating the token forwarding module would, in some exemplary embodiments, be an online device with software authorized by a service provider to transfer the tokens 112 to the backend system 108. It may be appreciated that the backend system 108 may be any system operating software to administrate, settle, and clear such tokens 112.

Further, in additional exemplary embodiments, a method of transferring the stored token 112 may be made in any of a variety of manners. For example: i) Use the authorized Token Forward software (TFS) in an online device, such the terminal device 106, or any other device operating and are authorized to operate the token forward software; ii) Record a video of the tokens 112 in a display-print mode and send the video to the backend system 108; iii) Connect a cable to the terminal device 106, if equipped with such cable connection (or any other wired or wireless data transmission protocol) and transfer the token to an alternative online device via USSD (Unstructured Supplementary Service Data) or any other authorized format of transfer; iv) IVR (Interactive Voice Response) transfer by voice recognition or by using of DTMF (Dual-Tone Multi-Frequency); and/or v) Connected to an offline device, print the token(s) 112 and fax deliver a token list, for further processing by a service provider. The described list (i-v) are a few examples, and the core-purpose is to make it possible to accept secure token payments even if there is no mobile phone network or internet available, which may be the case in rural areas or when there is a shortage of electricity, over a period of time. Thus, according to exemplary embodiments shown and described herein, a low-cost, high security payment and data transfer platform 101 may be provided. The platform 101 may provide inclusion and usability to both banked and unbanked users.

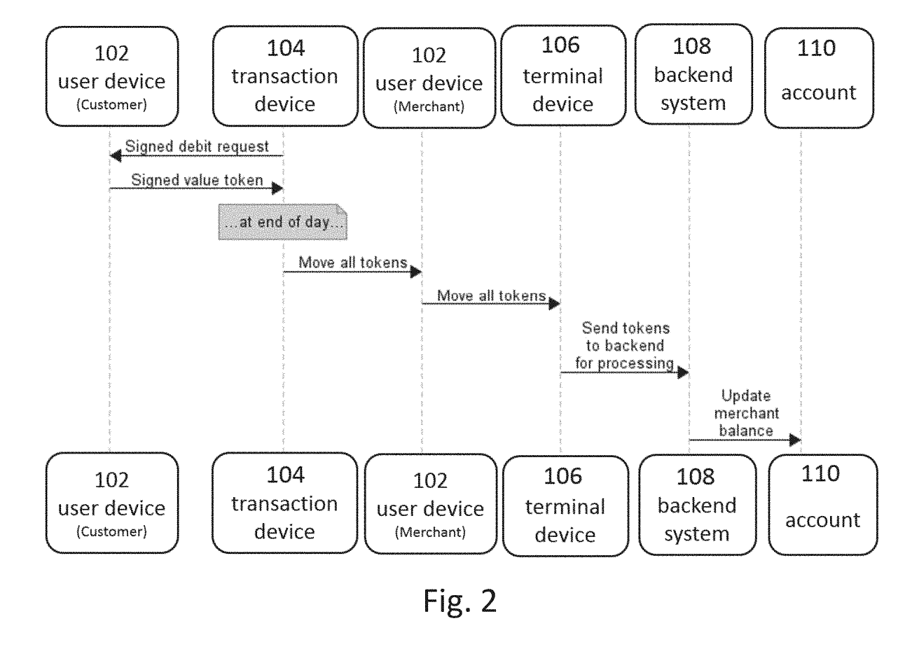

Turning now to exemplary FIG. 2, FIG. 2 shows an exemplary diagram of data flows. A payment method and the transaction platform 101 may be detailly described along with the data flow used therein. In the exemplary embodiment shown in FIG. 2, the following steps may take place:
a. A customer may place their user device 102 on the transaction device 104 and the card processing-unit of the user device 102 may receive a request for deducting such amount from the transaction device 104 and, if there is a sufficient value balance, may reply back with a cryptographically signed token 112 if the combined balance/credit allows it. According to an exemplary embodiment, the merchant may enter an amount on the transaction device 104 with a detailed item, which may result in a purchase amount, or transaction value. Also, it may be appreciated that a “value”, as used herein, may not only be money, but may also be electronic money, exchangeable points, mileage points, complimentary currencies, faux currencies, or any form of digital money or digital currency.
b. The transaction device 104 may verify the signature of the token 112 and may store the token 112 in an internal database. The transaction may now be completed from the customer's perspective.
c. At the end of the day or at any other desired or predetermined time, the merchant (or any authorized party operating the transaction device 104) may put their user device 102 on the transaction device 104 and transfer all collected tokens 112 into to the user device 102.
d. The merchant may then insert the user device 102 into the terminal device 106, or any other device operating a token forward module that may upload the tokens 112 to the backend system 108 for processing. Additionally, it may be appreciated that the merchant may use contact-less data transfer to upload the tokens 112. Further, as described above, the user device 102 may be a smart card or another type of device, such as a USB memory stick, SD card, or other such types of media, provided the transaction device 104 may have capabilities to write on that media.
e. The merchants' account 110 may then be credited with the value of the tokens 112 as long as they are valid (i.e. not already used).

Further to the above, the components and elements used in the payment and data transfer platform 101 may have any of a variety of advantages over existing platforms. The transaction device 104 may be made inexpensive and still be safe from fraud. Additionally, the transaction device 104 may be operated as an offline device to enhance security and speed of transactions. The operator of the transaction device 104 may upload its collected tokens 112 to the user device 102.

Additionally, in further exemplary embodiments, the owner/holder (the merchant) of the transaction device 104 may have its collected tokens 112 credited to its account 110, after that the tokens 112 have been uploaded to the backend system 108.

Further, the user device 102 may have asymmetrical crypto functions (or symmetrical crypto functions), in some exemplary embodiments. Also, as described above, the user device 102 may have an e-wallet with either pre-allocated money or with a line-of-credit decided by an issuer. This money may then be utilized in transactions and allocated or de-allocated as desired. For example, the user device 102 may be reloaded at the terminal device 106 or any device operating a proper load software, which also may be a service kiosk or ATM.

In still further exemplary embodiments, a device app may enable both the user (customer) and the merchant to access (read) data from the e-wallet on their device 102, such as a smartphone, tablet, or other communication or computing device, which can, in one example, display given (used) tokens 112 and also indicate if such token 112 was uploaded by the merchants, or the merchant may use their mobile phone to read, from their user device 102, the received tokens 112 via the mobile device app, that is an ‘online’ status of already uploaded tokens 112.

According to an exemplary embodiment, the transaction device 104 may be used in a taxi, tricycle, and bus or van transportation or airlines as well as tuck-tuck or any other purpose where other user devices 102 may be used. This may further include subways, trains, airlines, and the like. Also, in an exemplary embodiment, the transaction device 104 may also be enabled as a donation or e-Piggy (i.e. piggy bank) device.

It may be appreciated, however, that the transaction device 104 may not have to require that the holder has a mobile phone or any communication device available for enhancing the security benefits as an offline device. An exemplary method of having an offline solution where the transaction tokens 112 are stored may result in an improved safety method.

According to an exemplary embodiment, the transaction platform 101 may use the backend system 108 with e-HUB concept as a backbone, semi-open transaction facilitator and settlement solution, based on an open source resource fully autonomous method, whereby further cost reductions are a result, which make it possible to offer to a mass-market where the user (consumer) does not need to pay any transactions fees and where such economical solutions may be offered to the merchants without any transactions fees at all. The backend system 108 may also for a financial institution or a service provider which provides services as an aggregator. The Government may receive accurate information from the smallest vendor and any tax applicable may be accounted for in a highly secure manner, where fraud and detailed, costly administration procedures have been eliminated. Exemplary protections against fraud or security risks are described as follows.

Customer fraud may be prevented or minimized by the exemplary embodiments described herein. According to an exemplary embodiment, the data (token 112) of the secured user device 102 may not be altered by the customer/user. The only device that may increase the value on the user device 102 may be the terminal device 106. The terminal device 106 may be a secure POS device with layers of tamper protections features, manufactured and designed to be safe. In an exemplary embodiment, if the customers make their own device (copy/clone/piracy-copy) that speaks or spoofs the same protocol as the user device 102, the transaction device 104 may detect this since such a device may not have the correct private key for signing the reply. Further, in an exemplary embodiment, the security may further be improved by a key provided by the user device 102.

Merchant fraud may also be prevented by embodiments described herein. The merchant (or anyone who may have physical access to the transaction device 104) theoretically could alter the software of the transaction device 104. If the altered software in the transaction device 104 could request a higher amount than what is shown on the display on the transaction device 104. However, in some exemplary embodiments, the transaction device 104 software may not be manipulated in part, and if such a ‘hack’ is made, all of the software may have to be changed. Also, in an exemplary embodiment, since an operator may manage all tokens 112 in the database (backend system 108) before the token 112 is changed into an actual financial value, all transactions may be traced, so any fraud by the merchant can be detected. Exemplary embodiments herein may also include (1) a ‘Check Last Token’ method, in which the consumer may take their user device 102, select the function on a function key or a key-defined for such method, and thereafter touch their user device 102 on the transaction device 104 which may then display the last used token 112. An exemplary alternative way to achieve the same is to use a (2) NFC enabled alternative device, such as a mobile phone, and select an app, authorized by a service provider, which may then display latest generated token 112, or a list of tokens 112, and/or the balance and/or other information the user may request to display.

In some exemplary situations, the merchant could also generate fake tokens to try to fraud the service provider. According to an exemplary embodiment, this may be detected by the backend system 108 verifying the signature of the tokens 114 in addition to doing the already-used check. Further, consumers may use a mobile app, to see their used tokens 114, which may give an instant degree of verification and provide user comfort that the right amount was given to the merchants or use the method (2) above. Further, exemplary embodiments described herein may mitigate risk associated with more common payment transaction methodologies and provide additional consumer safety. The user device 102 which has a wallet is at risk if lost, but it may be secured by a PIN code to at least make stolen or lost user device 102 less vulnerable. A user device 102 with NFC or RFID communication capabilities and an embedded wallet may be ‘tapped’ or exploited on its stored values by a Piracy-Reader. However, such exploitations may be prevented both with the use of a defined Pin (Pin code) example as well as having the user device 102 equipped with an NFC ON-OFF function, in form of an antenna breaker (bottom), which may protect the user and prevent that the wallet may be exploited.

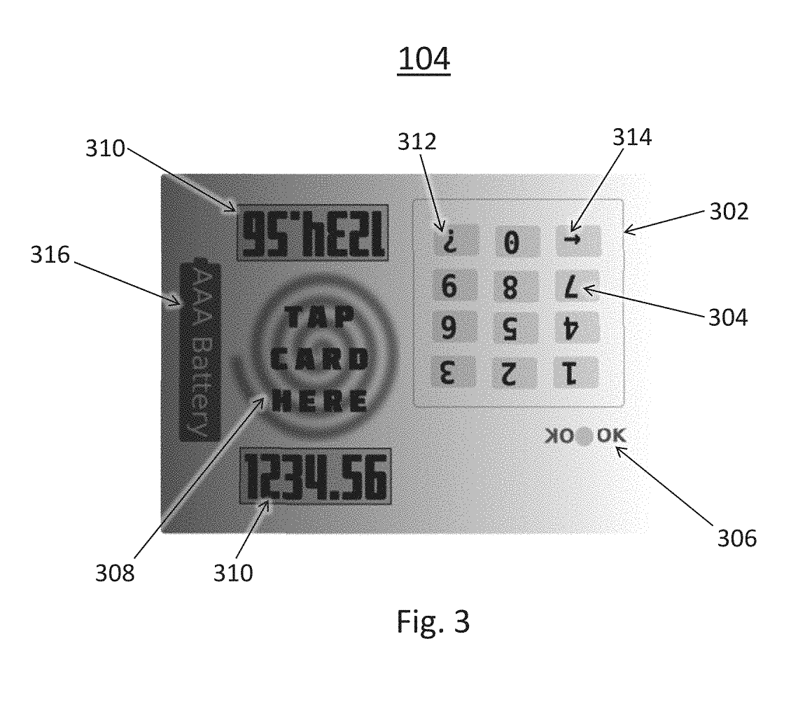

Turning now to exemplary FIG. 3, FIG. 3 shows exemplary configurations on the surface of the transaction device. According to an exemplary embodiment, the transaction device 104 may be placed on a merchant desk between the customer and merchant, so the transaction device 104 may have optionally two displays 310 for easy reading for both parties. Alternative methods of providing the transaction device 104 may also be utilized, and it is envisioned, for all devices described herein, that they may be formed having any of a variety of dimensions and can, in some exemplary embodiments, be embedded in other devices.

Referring still to exemplary FIG. 3, in one exemplary embodiment, if one of the number buttons are pushed down for X seconds, it may be used for a pre-programmed amount. Thus, for example, allowing for up to 10 fixed prices for items/services/groups. Further, various combinations of numbers may also be used or pre-programmed, as desired. For example, the “?” button 312 may be utilized for entering a menu where some additional functions may be added. Also, as an example, some additional functions may be displaying total amount stored, last transaction and settings of merchant card. Of course, other symbols, designs, emojis, or the like may be used on the button, as desired and may be programmed in any desired manner. Also, in an exemplary embodiment, the device may further have some extra function-keys which could be used to select a product group code which would be embedded in the transaction token 112. If the transaction device 104 and its method is being embedded in another type of ‘designed’ item such a donation device or any other device, the pictured keyboard may be replaced with a wheel where amount is selected or with different predefined touch-marked indicators.

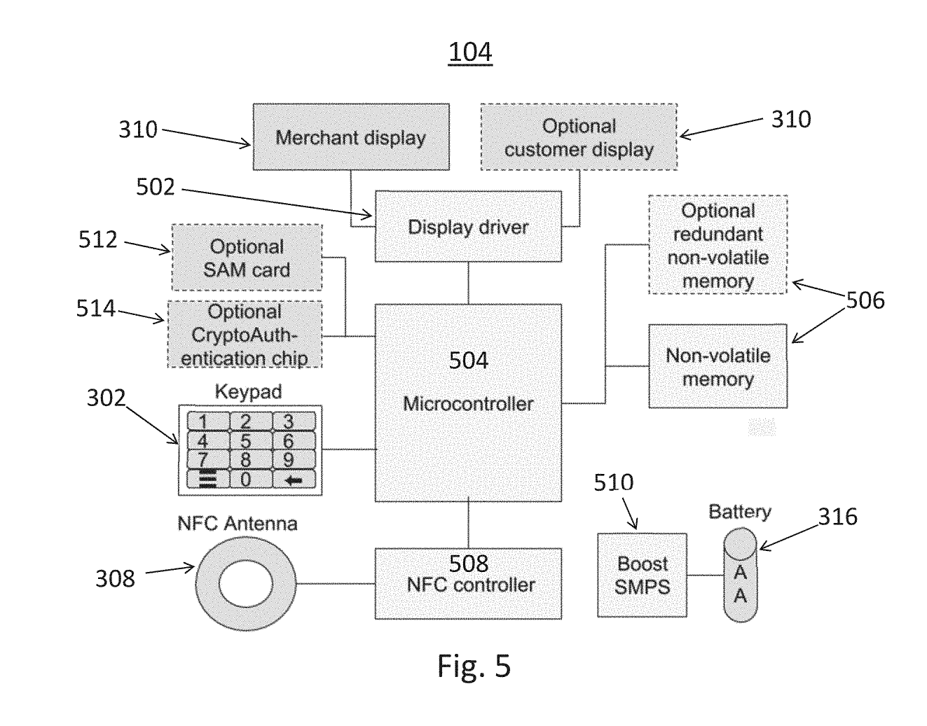

Turning now to exemplary FIG. 5, FIG. 5 shows internal configurations of the transaction device. According to an exemplary embodiment, the transaction device 104 may include merchant and/or customer displays 310, a display driver 502, a controller 504, one or more memories 506, a user device reader 308, a user device reader controller 508, a power source 316, and keypad 302. Additionally, an optional cable connector as well as optional function keys may be provided, as desired. Further in an exemplary embodiment, the number of the displays 310 and the number of the memories 506 may be optional. In one exemplary embodiment, the displays 310 of the transaction device 104 maybe LCD, LED, AMLED or any other kind of desired display type. The displays 310 may be driven by a display controller (display driver) 502 and, in some exemplary embodiments, the display controller 502 may drive both displays in parallel. Further, the display controller 502 may be connected to the controller 504. Again, it is envisioned that any other type of display or controller may be utilized, as desired.

Referring still to exemplary FIG. 5, the user device reader 308 may use RFID, NFC, or any other kinds of desired methods for communicating with the user device 102. For example, if the user device 102 is a contactless card, the card may be read by NXP MFRC522 or MFRC630 chip which may be connected by an I2C bus to the controller 504, or any other chip, as desired. The transaction device 104 may has a keypad 302, and the keypad 302 may be a custom “conductive silicone mat” that sits directly on top of the PCB. Also, in an exemplary embodiment, the transaction device 104 may has a power source 316 such as a battery, or any kind of power sources may be used for the transaction device 104. If the battery is used as the power source 316 of the transaction device 104, the voltage may be raised to the required voltage by a boost SMPS (Switched-Mode Power Supply) 510. The low current consumption, for example less than 50 mA, may make the SMPS 510 small and inexpensive. Again, other power solutions are envisioned, such as, but not limited to, solar power and the use of solar panels on the device.

Referring still to FIG. 5, additionally, in other exemplary embodiments, a microcontroller may be utilized as the controller 504 to be enough to perform RSA (Rivest Shamir Adleman) cryptography quickly and efficiently when verifying the signatures of the token 112 transactions. However, many low-cost microcontrollers may not have resistance against attacks of their memory contents, and it may problematic since each transaction device 104 may contain security keys that should not be disseminate to the public. According to an exemplary embodiment, in order to mitigate the vulnerabilities that might exist in the controller 504, either a SAM (Security Account Manager) module 512 or a specialized Crypto-Authentication chip 514 may optionally be added to the transaction device 104. In an exemplary embodiment, the SAM 512 may be in many different models and shapes. One possible type may include a standard ISO7816 contact smartcard that the merchant may semi-permanently insert into the transaction device 104 and may need to be activated with a PIN at every transaction, every X minutes or at every boot/wake-from-sleep. The SAM 512 may internally hold the security keys that normally should have been stored in the memory 506 of the controller 504. The security keys may then only be used inside the SAM 512 to verify & create signatures of transactions. Referring still to FIG. 5, according to an exemplary embodiment, a Crypto-Authentication chip 514 may be used in the same way, except that it may be permanently attached inside the transaction device 104.

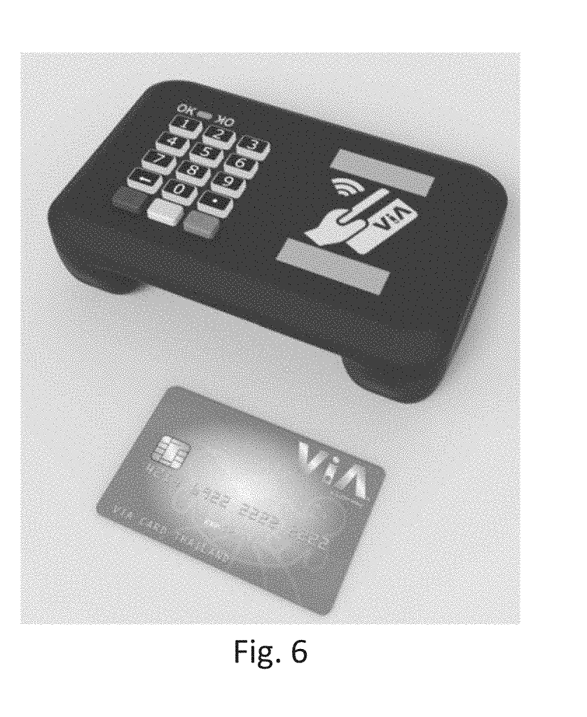

Exemplary FIG. 6 shows that an exemplary transaction device 104 is placed with an exemplary user device 102 such as a payment smart card. According to an exemplary embodiment, as described above, general data flows in a transaction chain of the platform 101 may include the following: a) the merchant enters an amount on the transaction device 104; b) the transaction device 104 creates a signed debit request; c) the customer taps their user device 102 on the transaction device 104 and the request is sent to the user device 102; d) the user device 102 deducts the requested amount from its internal wallet and generates a signed payment token 112; e) the user device 102 transmits the token 112 back to the transaction device 104 as a reply of the request; f) the transaction device 104 stores the token 112 in its memory 506; g) at the end of the day (or at any other point in time), the merchant taps his user device 102 on the transaction device 104 and initiates a transfer of all stored tokens 112 into his user device 102; h) the merchant taps his user device 102 on the terminal device 106 and transfers the tokens 112 into the terminal device 106; i) the terminal device 106 transfers the tokens 112 to the backend system 108 for processing; and j) the backend system 108 credits the merchant's account 110 with the amount of (validated) tokens 112.

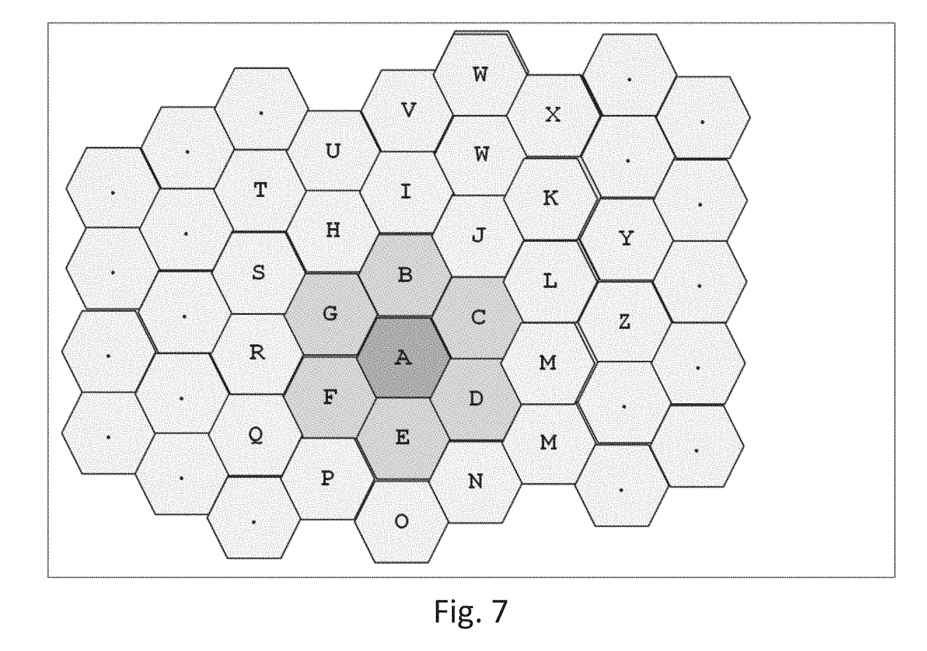

Turning now to exemplary FIG. 7, FIG. 7 shows a cryptographic key areas map. According to an exemplary embodiment, the embodiments described herein may include enhanced security features. Embodiments may include an innovative method to minimize a large problem when an encryption key has been leaked, hacked or compromised. Under the current state of the art in the financial card, mobile and device industry, when information is being protected by encryption, all involved elements of those transactions has ‘encryption key/s’. If the encryption key (or keys) has been leaked, hacked or compromised, the service provider, the issuer, the manufacture or distributer may need to recall all affected units and replace the compromised key/s. To recall a number of devices, whether it is a few or millions, it would be a big problem due to the cost of the recall. Also it would be a risk for users because it may cause the inability to access funds or the complete loss of funds or money. According to an exemplary embodiment, the crypto keys mobility method may reduce such risks and prevent the replacing all devices in case of a hack/leak of the private key of the devices as the keys may be grouped region-wise.

Referring to exemplary FIG. 7, in the exemplary embodiment, the concept of using the transaction platform 101 assumes that most transactions using the user device 102 may be done locally or in the surrounding neighborhoods, making it possible for the user device 102, the transaction device 104, or the terminal device 106 to store only a specific public key (the security key or the cryptographic key) in a local or home-area and the surrounding areas. For example, if the user device 102 is to be used outside of those areas, the key may have to be updated with relevant keys by simply visiting the terminal device 106 which located on that area and have the relevant public keys of that area downloaded into the user device 102. For example, if the user device 102 belongs to the “A” area, it may have the public keys for the B/C/D/E/F/G areas, as well as the A area, in its memory. If the user device 102 is to be used in for instance the H area, the user device 102 may be updated to support the H+U/I/B/G/S/T areas, as an example but not limited to. If a leak of a private key occurs, all devices only in that area may be replaced and/or securely updated with new keys. According to an exemplary embodiment, the user device 102 and/or the transaction device 104 may be updated at the terminal device 106 in that and surrounding areas to reflect the changes. The size, shape and number of areas that may be used may be evaluated in various ways. For example, the divided areas may not have to be symmetrical hexagonal shapes as in the drawing here, but rather some kind of Voronoi shapes based on population density and natural borders, for example.

Referring to exemplary FIG. 7, also, in an exemplary embodiment, the private keys on the user device 102 may be grouped as well. Since it would be difficult for the user device 102 to be updated with new keys every time the user device 102 enters different areas, the user device 102 may have a fixed list comprising all public keys which may be selected by the user of the user device 102.

As described herein, the usage of the exemplary embodiments may be in any of a variety of environments or purposes. Some exemplary uses are explained in more detail as follows. According to an exemplary embodiment, as described above, the transaction device 104 may be used in various manners for bus transportations, taxi, tricycles, vans or motorbike (taxis), as way of getting paid for their service in a safe and automatically administrated way. The operator of such service equipped with the transaction device 104 results in that both the user and the operator are part of a cashless e-society. The rate for the transportation may be a ‘default’ value displayed on the transaction device 104, which make the process of paying much faster.

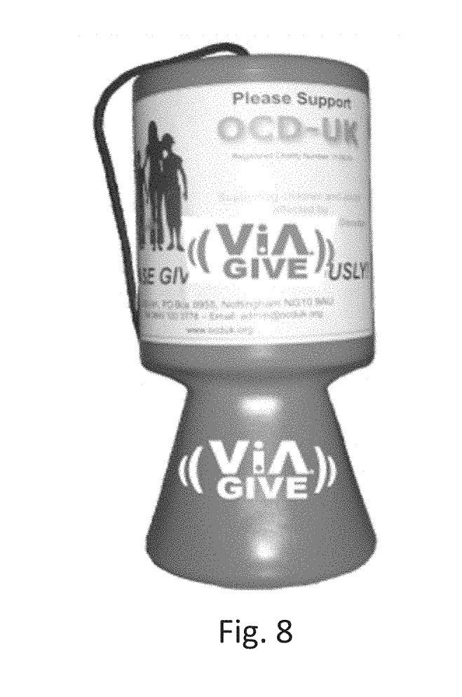

Turning now to exemplary FIG. 8, FIG. 8 shows an exemplary collection box which may be used as an e-piggy. Embodiments described herein may also be used as a savings tool. According to an exemplary embodiment, the transaction platform 101 may be used for a ‘piggybank’ model with a display and lights, and even a talking interface, saying ‘Thank you for feeding me with . . . ” or any other voice message or the device is made with only a sound, to indicate that the amount has been received. A wheel or a key-pad may be used to set the amount which should be given to the e-piggy.

When the owner/holder of the special designed device wants to move the ‘stored’ values, as one example: The parent/s, who may have a user device 102, would either enter a code or press a key to request to move the stored e-piggy amount to the user device 102. Thereafter, the parent (holder of the user device 102) goes to the collection box which could be also the transaction device 104, the terminal device 106, or a kind of ATM or any other type of device, inserts his or her user device 102 and select to transfer the user device 102 stored wallet amount, or part thereof to a defined account 110.

Embodiments described herein may also be used for donations or to facilitate donations. For example, at any place where a donation may be made, a transaction device 104, which may be made in any shape or form or built in to any type of device, where a ‘amount-wheel’ or ‘keypad’ or predefined ‘touch-areas’ or ‘fixed-values’ may be used to make a donation. This may solve a significant problem for both the donation recipient as well as for governments or for the donator, and provide a secure transaction, as well as easily accessible receipt of the donation. Embodiments described herein may also be used with respect to vending machines. A vending machine may be equipped with the transaction device 104 as an integrated unit or operate a software to accept a secure token 112 as a payment method. This may provide a secure method of donating and also provide the user with a receipt. According to an exemplary embodiment, the collection-box may easily become an e-Collection Box where either a few ‘Amount-Buttons’, a ‘Fixed-Amount’, a Keypad, or a ‘Amount-Wheel’ could let the donator select an amount to give. In an exemplary embodiment, the collection-box may be checked, and the received tokens 112 may be uploaded to the backend system 108. If the operator using an online device, such as a mobile phone with NFC, the upload may be made instantly and the backend system 108 may offer a broad range of features to the operators, with a diverse range of statistics as well as such features like sending the donator a message, via SMS, e-mail or any other mean of communication, to thank for the donation.

As per a business model of the transaction platform 101, such interaction would only take place between the service provider (operator) and the donator, the details of a donator would not be given to the operator. The only way to contact the donator would be to use the services offered by the service provider, to ensure 100% consumer protection and if there is a commercial value such revenues would be shared with the Donator in form of more purchase values. The business model of the transaction platform 101 would also, if so is requested offer the donator a ‘Track Donation’ service so that the donator may follow the donation and in some cases also pick items from an operator's donation-shop on how to use such donation and to where such donation shall be designated. Similarly, embodiments described herein could be used in a bagging device. A device which is made as a donation solution where the facing-side towards the user may have pre-printed or displayed displaying different amounts, and the user may just touch his card to the amount selected. Such device may also be equipped with another display showing how much which has been donated.

Turning now to exemplary FIG. 8, FIG. 8 shows an exemplary diagram of a worn user device with NFC or RFID capabilities. According to another exemplary embodiment, a wearable NFC/RFID (or the like) device may be utilized as the user device 102. In this example, if a student has a smart chip user-device, here illustrated with a wristband, it could be a student ID card or a key-ring or any other type of user device 102. When the student need to register for an event, enter a room, or pay or register a purchase of food, snacks or literature, each such location of commerce (POC) may be equipped with a user device 102. Such solution makes it cost effective and simple to manage as an alternative to a costly online solution.

In another exemplary embodiment, it may be assumed that a user is going to an event, such as a football match, music festival or any other event, where a ticket is typically needed or purchased (similar to airline, bus or other transportation tickets). In this example, the user may be given a user device 102 that is smart chip based and such user device 102 has an e-wallet. As a promotion, the wallet is preloaded with a predetermined amount and the user may directly or at any terminal device 106 re-load or fill up the wallet, use it as an event ticket, or the like.

In still other examples, when the popcorn vendor passes by the user's seat, the user would have needed to find ‘money’ in a wallet or pocket (a distraction from the event and likely distractions for the surrounding people). According to an exemplary embodiment, the user who has a user device 102 with an e-wallet, may touch the user device 102 to the transaction device 104 of the popcorn vendor and the payment is made. When the popcorn vendor returns to their station, the collected tokens 112 may be transferred to the vendors/merchants' user devices 102 and thereafter uploaded to the backend system 108, as described above.

In still other examples where a user (customer) has a personal relationship with a local shop or shops that are regularly visited, there is common theme that the customer put up the amount of a purchase on the ‘bill’ or ‘tab’ to then later, as agreed, settle the amount you do owe such shop (merchant). In many cases the shop owner doesn't even make a record of such event, he has it all in his head and it is all build on a mutual chain of trust and responsibility. Many shops (merchants) do make a record in a ‘book’ and when the user pays part of or the entire outstanding amount, the shop owner deletes the note or makes such payment as a new record. According to an exemplary embodiment, the transaction device 104 may, with a separate software module, also handle these types of events, by selecting such functions by a function key or a tab module that may be made to handle such specific type of transactions, where the user device 102 is used but does not generate a token 112. In an exemplary embodiment, the user device 102 may identify the user for the transaction device 104, and the transaction device 104 may record such an event and store the transaction in a secure token 112. The tab module may, as well, handle registrations of transactions by a ‘reference’ number, in such manner that the clerk (holding the transaction device 104) may select or enter a user number, which may be any number, 1, 2, or 3, or a mobile number or any other numbers. If the user's mobile number is recorded, it may be used for a letter or text to remind the tab. Also, by using the terminal device 106, scanning a bar code representing that user may be possible. In still other exemplary embodiments, a transaction device 104 may have the tab module with a short number or identifier for a customer. Alternatively, a customer name or code name could be displayed in the transaction device 104. In still other exemplary embodiments, a mobile number could also be displayed, as desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments may be made by those skilled in the art without departing from the scope of the invention as defined by the following claims.

What is claimed is:

1. A system for data transaction comprising:
at least one token;
at least one user device;
at least one transaction device configured to receive the at least one token from the at least one user device, or transmit the at least one token to the at least one user device;
at least one terminal device;
at least one account; and
at least one backend system configured to manage the at least one token and the at least one account, receive the at least one token from the at least one user device via the at least one terminal device, and transmit the at least one token to the at least one user device via the at least one terminal device,
wherein the at least one user device and the at least one transaction device transmit or receive the at least one token absent connection to a remotely located server.

2. The system of claim 1, wherein the at least one token is secured by at least one cryptographic key, the at least one cryptographic key is stored at least one of the user device, the transaction device, the terminal device and the backend system;
and at least one of the user device, the transaction device, the terminal device and the backend system verifies the at least one token by using the at least one cryptographic key.

3. The system of claim 1, wherein the at least one transaction device transmits a request to the at least one user device after signing the request by using at least one cryptographic key, and the at least one user device generates the at least one token after receiving the signed request from the at least one transaction device.

4. The system of claim 1, wherein the at least one token is transmitted from the at least one user device to the at least one transaction device after the at least one user device signs the at least one token by using at least one cryptographic key, and the at least one transaction device verifies the transmitted token by using the at least one cryptographic key.

5. The system of claim 1, wherein the at least one token is uploaded to the at least one account of the at least one backend system by using a token forward module of the at least one terminal device.

6. The system of claim 1, wherein the at least one user device and the at least one transaction device transmit or receive the at least one token via at least one of RFID and NFC.

7. The system of claim 1, wherein the at least one backend system manages the at least one token as a balance in the at least one account, the at least one user device includes an electronic wallet, and the electronic wallet generates the at least one token in response to the balance in the at least one account.

8. The system of claim 1, wherein the at least one user device is at least one of a smart card, a SIM card, a mobile phone, a USB memory with a controller and a SD card with the controller.

9. A transaction device comprising:
at least one display;
at least one display driver configured to drive the at least one display;
at least one user device reader configured to communicate with at least one user device;
at least one user device reader controller configured to communicate with the at least one user device reader;
at least one controller configured to communicate with the at least one display driver and the at least one user device reader controller;
at least one memory configured to communicate with the at least one controller;
at least one power source configured to supply power to the transaction device; and
at least one interface configured to receive and transmit data and communicate with the at least one controller.

10. The device of claim 9 wherein the at least one memory communicating with the at least one controller is secured by at least one of a SAM (Security Account Manager) module and a Crypto-Authentication module.

11. The device of claim 9, wherein the at least one user device reader is at least one of an RFID antenna and an NFC antenna, and the at least one user device reader controller is at least one of an RFID controller and a NFC controller.

12. The device of claim 9, wherein the at least one power source is at least one battery with a boost SMPS (Switched-Mode Power Supply).

13. The device of claim 9, wherein the at least one interface is a keypad.

14. The device of claim 9, wherein the at least one user device reader and the at least one user device reader receive and transmit the at least one token, the at least one memory stores the at least one token, and the at least one token is transacted by using at least one cryptographic key.

15. The device of claim 9, wherein a user saves at least one itemized amount of tokens in the at least one memory, and the controller transmits a request to the at least one user device via the at least one user device reader depending on the at least one itemized amount of tokens saved in the at least one memory.

16. A method of managing a cryptographic key comprising
dividing a map into a plurality of areas; and
assigning a cryptographic key in each divided area,
wherein the cryptographic key is assigned with a rule that the assigned cryptographic keys are same among the divided areas which share at least one border, and
wherein at least one transaction of tokens which occurs in an area uses the cryptographic key assigned to the area.

17. The method of claim 16, wherein the map is divided based on at least one of a population density and natural borders.

18. The method of claim 16, wherein an updating of the cryptographic key is performed in the divided areas which share at least one border at the same time.

19. The method of claim 16, wherein an updating of the cryptographic key is performed in at least one user device and at least one transaction device located in a divided area via at least one terminal device located in the divided area.

20. The method of claim 16, wherein at least one user device stores a list of the cryptographic keys assigned to a plurality of selected areas which selected by a user.
